(19) United States
(12) Patent Application Publication
(10) Pub. No.: US 2017/0232726 A1
(43) Pub. Date: Aug. 17, 2017

(54) PROFILED SQUEEGEE BLADE WITH INTEGRATED PASTE DEFLECTORS

(71) Applicant: Ricky Paul Bennett, Flemington, NJ (US)

(72) Inventor: Ricky Paul Bennett, Flemington, NJ (US)

(21) Appl. No.: 15/199,614

(22) Filed: Jun. 30, 2016

Related U.S. Application Data
(60) Provisional application No. 62/293,981, filed on Feb. 11, 2016.

(51) Int. Cl. B41F 15/44

(52) U.S. Cl. CPC B41F 15/44

(57) ABSTRACT

A printing squeegee has multiple profiles formed into the face of the squeegee to combine 45 and 60 degree angles of attack simultaneously. Additional profiles can be added to optimize the blade performance. Wings are integrated into the blade to retain the print medium and to restrict the blade from over flexing. The one-piece blade with integrated wings and multiple face profiles can increase print speed and control the angle of attack of the blade.

### CROSS-REFERENCE TO RELATED APPLICATIONS

This application claims the benefit of priority to U.S. provisional patent application No. 62/293,981, filed Feb. 11, 2016, the contents of which are herein incorporated by reference.

### BACKGROUND OF THE INVENTION

1. Field of the Invention

One or more embodiments of the invention relates generally to squeegee blades. More particularly, the invention relates to a polymer profiled squeegee blade with integrated paste deflectors.

2. Description of Prior Art and Related Information

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Screen printing is a printing technique whereby a mesh is used to transfer ink onto a substrate, except in areas made impermeable to the ink by a blocking stencil. A blade or squeegee is moved across the screen to fill the open mesh apertures with ink, and a reverse stroke then causes the screen to touch the substrate momentarily along a line of contact. This causes the ink to wet the substrate and be pulled out of the mesh apertures as the screen springs back after the blade has passed. Stencil printing typically uses a solid mask or template made of stainless steel or other material which has 100% open area apertures that allows higher viscosity printing materials with larger solid content such as solder paste to pass through. This latter technique, typically known as Surface Mount Technology, will be used as the theme towards this invention.

A screen printing machine includes a squeegee device and a screen mask. The squeegee device is arranged above the screen mask. The squeegee device includes a device body, a squeegee holder, and a squeegee. The squeegee is mounted on the squeegee holder.

Current squeegee blade designs are restricted to a fixed angle of attack, typically 45 and 60 degrees to the printing surface. This type of blade is flexible and is prone to over flexing with increased downward pressure and increased speed, which can create poor printing quality.

Current squeegee blades are typically made of metal. These metal blade often wear down the stencil/mask, which is also made of metal. This metal-to-metal wearing eventually results in the need for new blades and/or new stencils.

The current squeegee blade design is housed in a holder which may have wings attached to the holder for print medium retainment. These wings (paste deflectors) require adjustment to contain the print medium and are independent of the blade.

In view of the foregoing, it is clear that these traditional techniques are not perfect and leave room for more optimal approaches. As can be seen, there is a need for a squeegee blade design that may have a multiple profiles and integrated wings.

### SUMMARY OF THE INVENTION

Embodiments of the present invention provide a printing squeegee comprising a polymer material having a front face disposed between first and second sides thereof; a profile design formed in a portion of the front face; and wings integrated into the first and second sides.

Embodiments of the present invention further provide a printing squeegee comprising a polymer material having a front face disposed between first and second sides thereof; a profile design formed in a portion of the front face; and wings integrated into the first and second sides, wherein the wings extend from a plane of the front face at an angle from about 10 to about 80 degrees; and bottom edges of the wings are angled to contact a surface when the squeegee is pressed thereagainst, wherein the bottom edge prevents overflexing of the squeegee.

In some embodiments, the profile design is a semi-circular protrusion extending from a plane of the front face. In other embodiments, the profile design is a three or more sided shape extending from the front face at an angle. The angle can be from about 30 to about 60 degrees, for example.

In some embodiments, the profile design is shaped from the material forming the front face. In other embodiments, the profile design is pre-formed and affixed as a separate element to the front face.

In some embodiments, slots are cut into the squeegee, the slots communicating with an upper edge of the squeegee to permit the squeegee to be slid onto protrusions of a squeegee holder.

These and other features, aspects and advantages of the present invention will become better understood with reference to the following drawings, description and claims.

### BRIEF DESCRIPTION OF THE DRAWINGS

Some embodiments of the present invention are illustrated as an example and are not limited by the figures of the accompanying drawings, in which like references may indicate similar elements.

FIG. 1 is a perspective view of a squeegee design according to an exemplary embodiment of the present invention;

FIG. 2A is a cross-sectional view of the squeegee design of FIG. 1 used in a printer, showing pressure applied so the wings contact the printing surface;

FIG. 2B is a cross-section view of the squeegee design of FIG. 1, showing a space between the wings and the printing surface prior to applying pressure;

FIG. 3A is a perspective view of a squeegee design according to another exemplary embodiment of the present invention

FIG. 3B is a side view of the squeegee design of FIG. 3A;

FIG. 4 is a perspective view of a squeegee blade design according to another exemplary embodiment of the present invention;

FIGS. 5A through 5C show conventional squeegee blades in use with a solder paste roll; and

FIG. 6 shows the profiled squeegee blade of the present invention in use with a solder paste roll.

Unless otherwise indicated illustrations in the figures are not necessarily drawn to scale.

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

### DETAILED DESCRIPTION OF THE PREFERRED EMBODIMENTS AND BEST MODE OF INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

As is well known to those skilled in the art, many careful considerations and compromises typically must be made when designing for the optimal configuration of a commercial implementation of any apparatus, and in particular, the embodiments of the present invention. A commercial implementation in accordance with the spirit and teachings of the present invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Broadly, an embodiment of the present invention provides a printing squeegee having multiple profiles formed into the face of the squeegee to combine 45 and 60 degree angles of attack simultaneously. Additional profiles can be added to optimize the blade performance. Wings are integrated into the blade, with or without the profiled face, to retain the print medium and to restrict the blade from over flexing. The one-piece blade with integrated wings and multiple face profiles can increase print speed and control the angle of attack of the blade.

The wings (also referred to as paste deflectors or deflector wings) help contain a solder bead within the printing face of the squeegee blade. Conventionally designed paste deflectors allow leakage to occur and therefore waste a large quantity of print medium. This is due to the paste deflectors being attached independently to the blade face and therefore unable to contain the solder paste within the required printing area. To compensate for the leakage/loss due to the design of conventional paste deflectors, a large quantity of solder paste is used to build/print product in a manufacturing environment. This results in a significant amount of paste waste.

As described in greater detail below, based on the paste roll dynamics and solder paste management compared to conventional squeegee blades and holders, embodiments of the present invention provide an integrated paste deflector, which results in less print medium waste, less print medium used, and the feature that the blades can be customized to product length, where conventional blades require customized holders. Additionally, embodiments of the present invention provide a profiled blade which provides benefits including the requirement for less paste for paste roll, the creation of more dynamic downward pressure and therefore not dependent on blade angle of attack, the creation of more dynamic downward pressure therefore allowing higher print speeds to be obtained; a paste roll size that does not influence paste deposition, and paste wicking up the blade face is dramatically reduced.

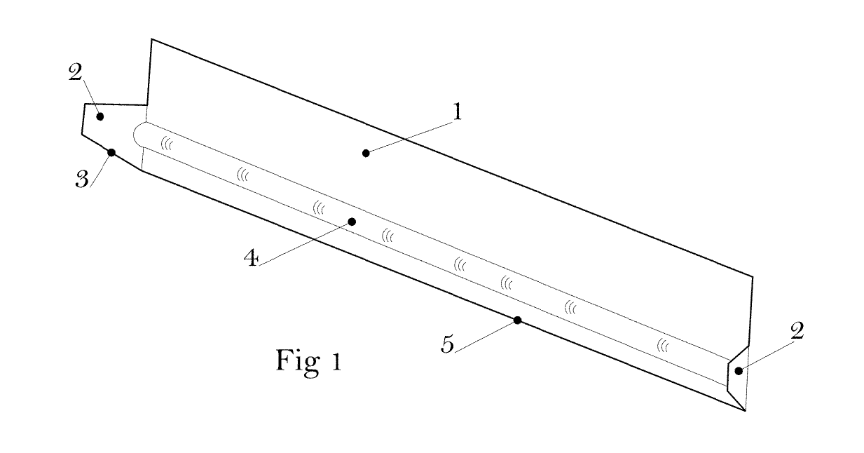

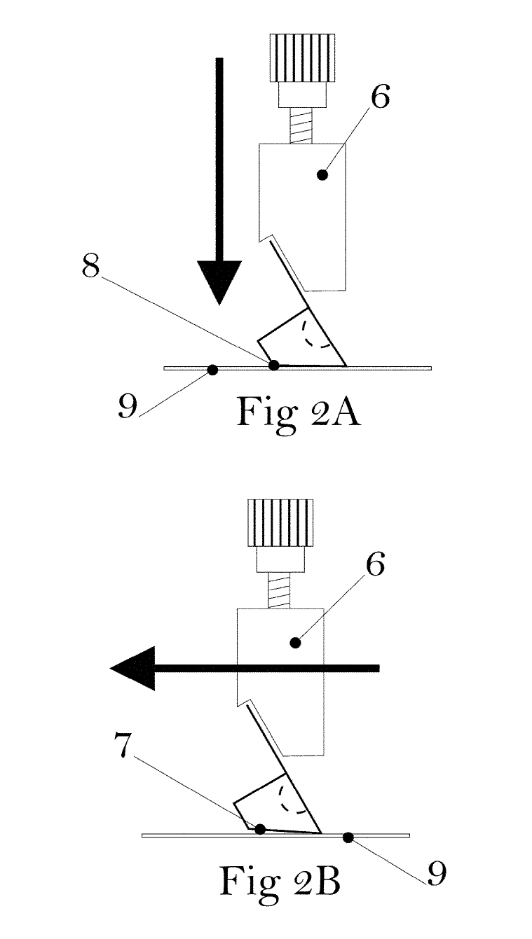

Referring now to FIGS. 1, 2A and 2B, a polymer blade 1 may be cut to an application specific size. Deflector wings 2 may be heated and folded towards the front, forming an angle from about 10 to about 80 degrees, typically approximately 45 degrees, relative to the plane of the blade 1. In some embodiments, the deflector wings 2 may be made separately and either pushed on the edges of the blade 1 or an adhesive could attach the deflector wings 2 on the edges of the blade 1. A half round profile 4 may be created by heating the blade 1 and pressing the shape from the back of the blade 1. In some embodiments, the profile 4 (or the profile 10 described below, for example) may be made separately and attached to the blade using an adhesive or other attachment methods. While the blade is described as a polymer blade, the blade may be made from various materials as may be contemplated by one of ordinary skill in the art.

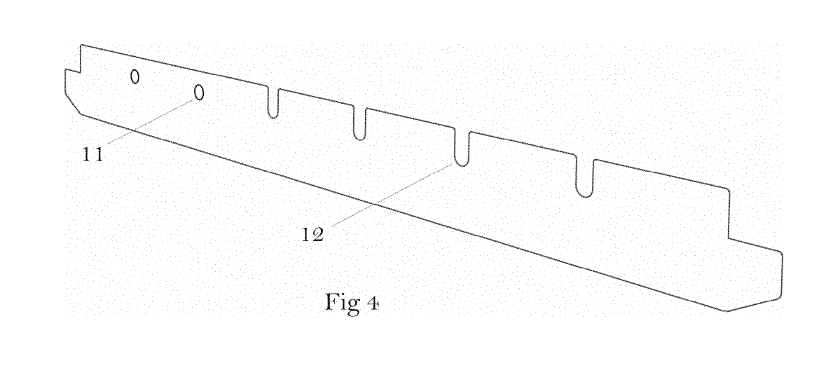

The profiled blade 1 may be placed into a holder 6 and mounted to the equipment using the blade. Various methods of mounting the blade 1 may be achieved via holes, slots, or the like. FIG. 4 shows one embodiment, where the blade includes holes 11 and/or slots 12. The slots 12 may be used so the squeegee holder 6 does not require screws to be removed from holder to mount the blade 1. In this embodiment, the screws (not shown) of the holder 6 can be loosened and blade 1 either removed or inserted. This can result in blade application that is quicker and cleaner than conventional methods, requiring removal of one or more screws.

Print medium 9 may be placed on the print surface (meshed screen or metal mask). The squeegee blade holder 6 and blade 1 may be lowered to the print surface 9 and an appropriate amount of pressure is applied. Without a downward pressure, the deflector wings 2 may not be in contact with the printing surface 9 as shown in FIG. 2B by the space 7 therebetween. With downward pressure applied, the deflector wings 2 come in contact 8 with the printing surface 9, sealing the blade 1 as illustrated in FIG. 2A. The blade 1 may flex until the deflector wings 2 come in contact with the printing surface 9. This design may prevent over flexing of the blade 1.

The blade itself may have some flex backwards, but will be constrained to this when either forward movement occurs or when pressure is applied. The blade can push the print medium in the direction of travel and create a forward rolling action on the medium. Depending on the profile used, the print medium will have a downward force applied, pushing the print medium toward the printing surface. The closer the print medium comes to the printing edge of the polymer blade, the forces increase, pushing more print medium into the masked-defined open apertures. The polymer blade printing edge is positioned more upright, and therefore, has less downward pressure on the print medium and, therefore, creates a scraping action, shearing the print medium and leaving a greater condensed deposit with a clean, scraped topography. With greater downward forces achieved with combined profiles, higher speeds of squeegee travel can be achieved.

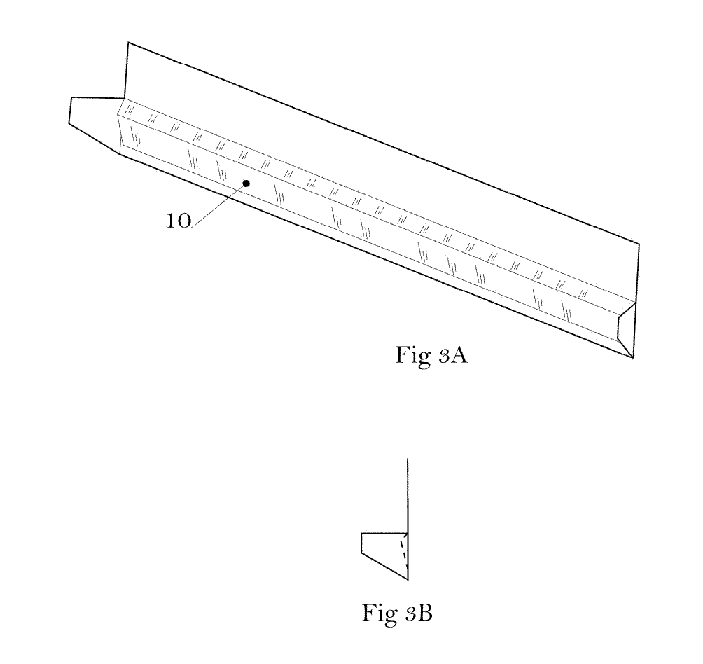

As shown in FIGS. 3A and 3B, different blade face profiles may be achieved by applying a different shape when the polymer blade material is heated. For example, a trapezoidal shape profile 10 may display a 45-degree profile. The shape may be any multi-sided shape, where the shape can extend from a plane of the front face at an angle from about 30 to about 60 degrees.

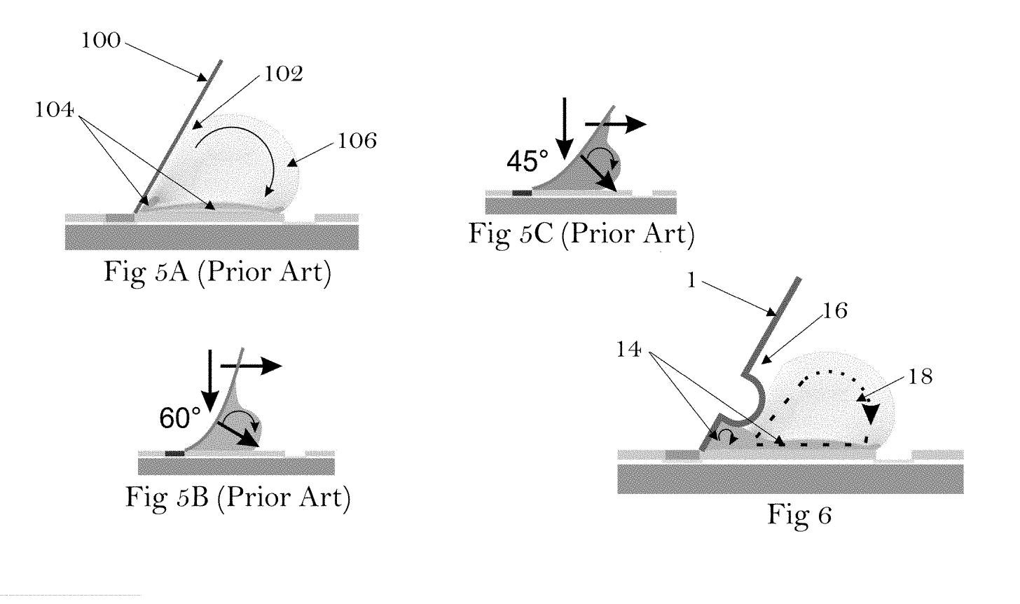

FIGS. 5A through 5C shows conventional blade 100 acting on solder paste 106. As can be seen, the solder paste sticks to the blade 100 at 102, starving the paste roll and increasing the amount of solder paste needed as well as paste waste. The solder paste roll greatly influences the forces at the concentrated forces 104 at the blade tip and stencil surface. Thus, as the solder paste roll starts out as a large roll, the size of the roll diminishes, the print deposition is affected negatively. FIG. 5B shows a widely used, cleaner stencil wipe at an angle greater than 45 degrees. The angle of attack deforms under pressure and results in a wider operating pressure. FIG. 5C shows an embodiment typically used for through hole printing.

Referring now to FIG. 6, the profiled squeegee blade 1 results in a minimized influence of the initial solder paste roll 18 on print forces at the blade tip. This is because there is a localized paste roll 14 at the blade tip, as shown in the Figure. Also, the profiled squeegee blade has less solder attached to the blade surface and, therefore, less paste waste. In this embodiment, with the profiled blade face, the dynamic nature of the paste roll results in a greatly lessened requirement in the amount solder paste needed for the dynamic roll to occur. By combining the profiled blade design with the integrated solder paste deflectors, the result is not only superior print consistency and efficiency, but also the paste waste is significantly reduced.

The blade 1, 10 could be made by various techniques as are known in the art. In some embodiments, a pattern could, for example, be stamped or machined from a polymer material. The pattern can have a variety of lengths, depending on the application required. This pattern can then be placed into a thermo forming mold and placed into a heated oven at 320° F. for about 2 hours. The blade and mold is then compressed to form the blade into the desired shape. An alternate method could use polymer beads and create and injection molded tool per size and profile requirements. If materials other than polymers are used, such as steel, high heat and a press could be used.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Claim elements and steps herein may have been numbered and/or lettered solely as an aid in readability and understanding. Any such numbering and lettering in itself is not intended to and should not be taken to indicate the ordering of elements and/or steps in the claims.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what incorporates the essential idea of the invention.

What is claimed is:

1. A printing squeegee comprising:
a squeegee blade having a front face disposed between first and second sides thereof;
a profile design formed in a portion of the front face; and
wings integrated into the first and second sides.

2. The printing squeegee of claim 1, wherein the profile design is a semi-circular protrusion extending from a plane of the front face.

3. The printing squeegee of claim 1, wherein the profile design is a three or more sided shape extending from the front face at an angle.

4. The printing squeegee of claim 3, wherein the angle is from about 30 to about 60 degrees.

5. The printing squeegee of claim 1, wherein the profile design is shaped from the material forming the front face.

6. The printing squeegee of claim 1, wherein the profile design is pre-formed and affixed as a separate element to the front face.

7. The printing squeegee of claim 1, wherein the wings extend from a plane of the front face at an angle from about 10 to about 80 degrees.

8. The printing squeegee of claim 1, wherein bottom edges of the wings are angled to contact a surface when the squeegee is pressed thereagainst, wherein the bottom edge prevents overflexing of the squeegee.

9. The printing squeegee of claim 1, further comprising slots cut into the squeegee, the slots communicating with an upper edge of the squeegee, the slots permitting the squeegee to be slid onto protrusions of a squeegee holder.

10. A printing squeegee comprising:
a squeegee blade having a front face disposed between first and second sides thereof;
a profile design formed in a portion of the front face; and
wings integrated into the first and second sides, wherein
the wings extend from a plane of the front face at an angle from about 10 to about 80 degrees; and
bottom edges of the wings are angled to contact a surface when the squeegee is pressed thereagainst, wherein the bottom edge prevents overflexing of the squeegee.

11. The printing squeegee of claim 10, further comprising slots cut into the squeegee, the slots communicating with an upper edge of the squeegee, the slots permitting the squeegee to be slid onto protrusions of a squeegee holder.

12. The printing squeegee of claim 10, wherein the profile design is a semi-circular protrusion extending from a plane of the front face.

13. The printing squeegee of claim 10, wherein the profile design is a three or more sided shape extending from the front face at an angle.

14. The printing squeegee of claim 13, wherein the angle is from about 30 to about 60 degrees.

15. The printing squeegee of claim 10, wherein the profile design is shaped from the material forming the front face.

16. The printing squeegee of claim 10, wherein the profile design is pre-formed and affixed as a separate element to the front face.

17. A printing squeegee comprising:
a squeegee blade having a front face disposed between first and second sides thereof; and
wings integrated into the first and second sides.

18. The printing squeegee of claim 17, further comprising slots cut into the squeegee, the slots communicating with an upper edge of the squeegee, the slots permitting the squeegee to be slid onto protrusions of a squeegee holder.

19. The printing squeegee of claim 17, further comprising a profile design formed in a portion of the front face.

20. The printing squeegee of claim 17, wherein:
the wings extend from a plane of the front face at an angle from about 10 to about 80 degrees; and
bottom edges of the wings are angled to contact a surface when the squeegee is pressed thereagainst, wherein the bottom edge prevents overflexing of the squeegee.
